(19) United States
(12) Patent Application Publication
(10) Pub. No.: US 2025/0148425 A1
(43) Pub. Date: May 8, 2025

(54) FUSION DETECTION SYSTEM AND FUSION DETECTION METHOD

(71) Applicant: LITE-ON SINGAPORE PTE. LTD., Singapore (SG)

(72) Inventors: Wei SAI, Singapore (SG); Krishna Kumar Govindasamy, Singapore (SG); Nandha Kumar Kandasamy, Singapore (SG); Jia Sheng Ng, Singapore (SG)

(21) Appl. No.: 18/599,260

(22) Filed: Mar. 8, 2024

Related U.S. Application Data
(60) Provisional application No. 63/547,406, filed on Nov. 6, 2023.

(51) Int. Cl. G06Q 10/20; G05B 23/02

(52) U.S. Cl. CPC G06Q 10/20; G05B 23/0283

(57) ABSTRACT

A fusion detection system includes the following elements. A data classification unit, for receiving several sensing data of several distributed devices, and classifying the sensing data as a first type, a second type, a third type and a fourth type. An anomaly detection unit, for performing an operation of an anomaly detection model based on the sensing data of the first type and the second type to generate an anomaly detection prediction result. A predictive maintenance unit, for performing an operation of a predictive maintenance model based on the sensing data of the first type, the second type, the third type and the fourth type and the abnormality detection prediction result to generate a predictive maintenance prediction result. A cost optimization unit, for performing an operation of a cost optimization model based on the predictive maintenance prediction result to generate a cost optimization decision.

This application claims the benefit of U.S. provisional application Ser. No. 63/547,406, filed Nov. 6, 2023, the disclosure of which is incorporated by reference herein in its entirety.

### TECHNICAL FIELD

The present disclosure relates to an anomaly detection mechanism, and more particularly, relates to a fusion detection system and a fusion detection method applied to distributed devices in a micro-grid.

### BACKGROUND

With the evolution of newly-developed energy technologies, various types of energy systems have been provided, including home photovoltaics (PV) systems, PV farms, wind farms and battery energy storage systems (BESS). When the aforementioned various types of energy systems operate, anomaly detection and maintenance of the devices (such as distributed devices) in the energy system are required.

However, the devices in the energy system include many types. For accurately and immediately detecting the anomaly state of various types of devices, and effectively maintaining the anomaly devices, that poses a great challenge to the industry in this technical field.

In view of the above issues, it is desirable to have an improved anomaly detection mechanism, which can perform real-time anomaly detection and optimal predictive maintenance for the devices in the energy systems.

### SUMMARY

According to one embodiment of the present disclosure, a fusion detection system is provided. The fusion detection system includes the following elements. A data processing module, for performing a pre-processing on a sensing data-set, the sensing data-set comprises a plurality of sensing data of a plurality of distributed devices. A data classification unit of and the data processing module, for receiving the sensing data and classifying the sensing data into a first type, a second type, a third type and a fourth type, the sensing data are captured by a data capturing device. An anomaly detection unit, for performing an operation of an anomaly detection model based on the sensing data of the first type and the second type to generate an anomaly detection prediction result. A predictive maintenance unit, for performing an operation of a predictive maintenance model based on the sensing data of the first type, the second type, the third type and the fourth type and the anomaly detection prediction result to generate a predictive maintenance prediction result, the predictive maintenance prediction result is used to plan a predictive maintenance policy. A cost optimization unit, for performing an operation of a cost optimization model based on the predictive maintenance prediction result to generate a cost optimization decision.

According to another embodiment of the present disclosure, a fusion detection method is provided. The fusion detection method includes the following steps. Capturing a plurality of sensing data from a plurality of distributed devices by a data capturing device, and the sensing data form a sensing data-set. Performing a pre-processing on the sensing data-set by a data processing module. Receiving the sensing data of a plurality of distributed devices and classifying the sensing data into a first type, a second type, a third type and a fourth type, by a data classification unit of the data processing module. Performing an operation of an anomaly detection model based on the sensing data of the first type and the second type to generate an anomaly detection prediction result, by an anomaly detection unit. Performing an operation of a predictive maintenance model based on the sensing data of the first type, the second type, the third type and the fourth type and the anomaly detection prediction result to generate a predictive maintenance prediction result, by a predictive maintenance unit, the predictive maintenance prediction result is used to plan a predictive maintenance policy. Performing an operation of a cost optimization model based on the predictive maintenance prediction result to generate a cost optimization decision, by a cost optimization unit.

### BRIEF DESCRIPTION OF THE DRAWINGS

FIG. 1 is an application of the fusion detection system of the present disclosure.

FIG. 2 is another example of application of the fusion detection system of the present disclosure.

FIG. 3 is a block diagram of a fusion detection system according to an embodiment of the present disclosure.

FIG. 4A is a data structure used by the anomaly detection unit when performing model operations.

FIGS. 4B and 4C illustrate an operating process of the anomaly detection unit.

FIG. 5A is a data structure used by the predictive maintenance unit when performing model operations.

FIGS. 5B and 5C illustrate an operating process of the predictive maintenance unit.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

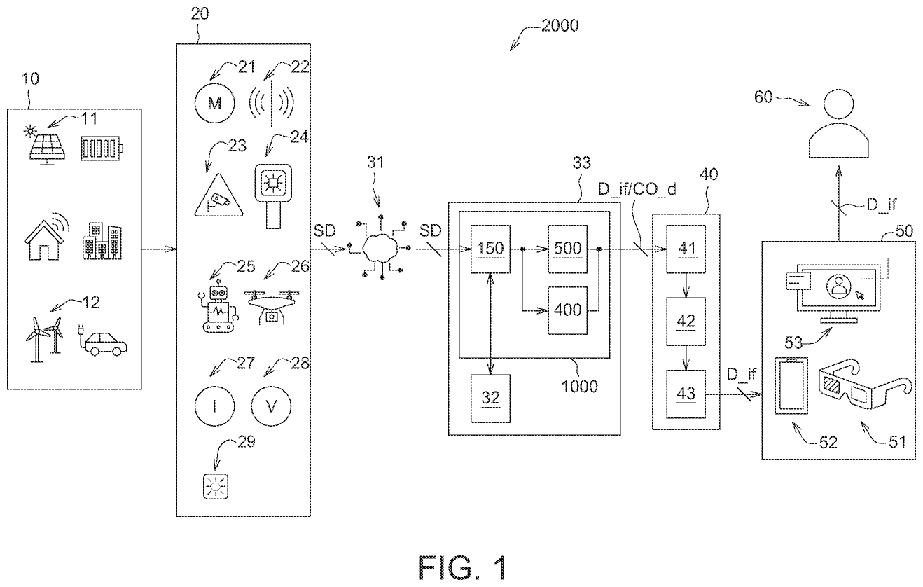

Please refer to FIG. 1, which illustrates an application of the fusion detection system 1000 of the present disclosure. The fusion detection system 1000 may be applied to a micro-grid, which includes distributed devices 10. The fusion detection system 1000 is used to detect an anomaly state of each of the distributed devices 10, and to plan predictive maintenance strategies. The distributed devices 10 include, e.g., a photovoltaic panel 11 and a wind turbine 12, etc.

The fusion detection system 1000 receives a sensing data-set SD, and the sensing data-set SD is provided by a data capturing device 20. The data capturing devices 20 include, e.g., a smart meter 21, a temperature sensor 22, a camera 23, an infrared sensor 24, a robot sensor 25, an unmanned aerial vehicle (UAV) sensor 26, a current sensor 27, a voltage sensor 28 and a weather sensor 29, etc. In one example, the data capturing devices 20 may be disposed on the distributed devices 10 and are used to capture sensing data of the distributed devices 10. For example, the sensing data captured by the camera 23 are visible images, and the sensing data captured by the infrared sensor 24 are thermal images. These sensing data captured by the data capturing devices 20 may form a sensing data-set SD.

In operation, the fusion detection system 1000 may be integrated into an Internet of Things (IoT) architecture 2000, and the distributed devices 10 and the data capturing devices 20 are parts of the IoT architecture 2000. Other than the distributed device 10 and the data capturing device 20, the IoT architecture 2000 further includes an edge gateway 31, an edge server 33 and a cloud computing platform 40. The edge server 33 includes an edge database 32, and the fusion detection system 1000 may be installed or disposed in the edge server 33. For example, the fusion detection system 1000 may be implemented by a hardware element or a software program in the edge server 33. The data capturing devices 20 transmit the sensing data-set SD to the edge server 33 through the edge gateway 31, and the sensing data-set SD may be stored in the edge database 32 of the edge server 33.

More particularly, the fusion detection system 1000 at least includes a data processing module 150, an anomaly detection unit 400 and a predictive maintenance unit 500. In the embodiment of FIG. 1, the data processing module 150 may receive the sensing data-set SD from the edge gateway 31. Furthermore, the sensing data-set SD may be stored in the edge database 32 of the edge server 33 through the data processing module 150.

The data processing module 150 performs pre-processing on the sensing data-set SD, e.g., data processing and transformation, and data mining. Wherein, data processing and transformation may include filtering processing, conversion processing, separation processing and compression processing. The pre-processed sensing data-set SD is sent to the edge database 32 for storage. The anomaly detection unit 400 performs anomaly detection (AD) based on the pre-processed sensing data-set SD, and the predictive maintenance unit 500 performs predictive maintenance (PM) based on the pre-processed sensing data-set SD, so as to generate a device information D_if. In addition, the fusion detection system 1000 further includes a cost optimization unit (not shown in FIG. 1) to perform a model operation for cost optimizing, thereby generating a cost optimization decision CO_d.

The device information D_if includes a device state, a device location and a device type of each of the distributed devices 10. The device state includes an anomaly state A_s. Moreover, the cost optimization decision CO_d includes an anomaly detection decision and a predictive maintenance decision. The predictive maintenance decision includes optimal maintenance schedule O_M_s. Moreover, the anomaly detection decision includes alerts and device health indicators (DHI). The device health indicators include, e.g., a probabilistic anomaly score (PAS), a mean time between failures (MTBF), a failure rate (FR) and remaining useful life (RUL) of each of the distributed devices 10.

The cloud computing platform 40 receives the device information D_if and the cost optimization decision CO_d from the edge server 33. The cloud computing platform 40 includes a message broker unit 41, a data streaming unit 42 and a cloud database 43. The device information D_if and the cost optimization decision CO_d are processed by the message broker unit 41 and the data streaming unit 42, and then stored in the cloud database 43. Furthermore, the device information D_if is sent to the terminal device 50.

The terminal device 50 includes, e.g., a head-mounted device (HMD) 51, a smart phone 52 and a display 53. The terminal device 50 may display the device information D_if, so as to present the device information D_if to the user 60. The user 60 is, e.g., an operator of the micro-grid.

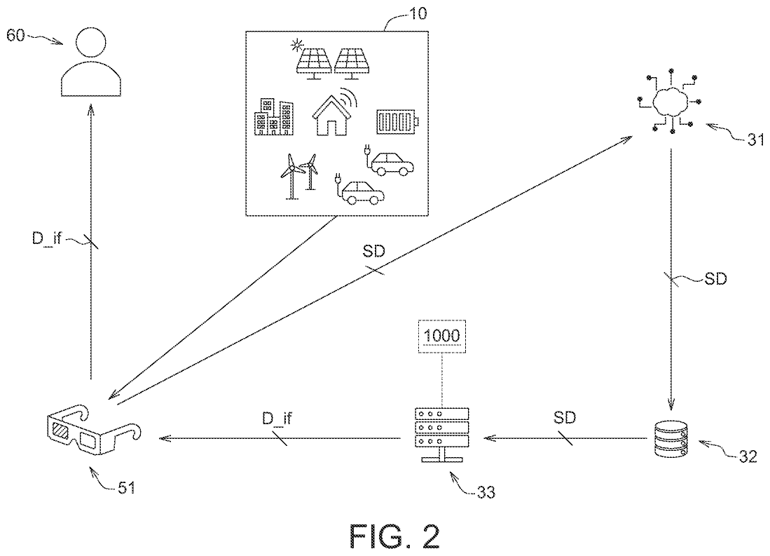

Please refer to FIG. 2, which illustrates another example of application of the fusion detection system 1000 of the present disclosure. In the example of FIG. 2, the head-mounted device 51 of the user 60 is utilized to capture the sensing data of the distributed devices 10, which is different from the example of FIG. 1 (in the example of FIG. 1, the data capturing devices 20 are utilized to capture the sensing data, and the data capturing devices 20 are installed on the distributed devices 10).

More specifically, in this embodiment, each of the distributed devices 10 has a visual device marker. Correspondingly, the head-mounted device 51 is equipped with a built-in camera or a built-in infrared sensor. The user 60 observes the device marker of each of the distributed devices 10 through the head-mounted device 51, and the built-in camera or built-in infrared sensor of the head-mounted device 51 may capture the image of respective device marker of each of the distributed devices 10. The plurality of image data captured by the head-mounted device 51 form the sensing data-set SD.

In the embodiment of FIG. 2, the sensing data-set SD may be transmitted to the edge database 32 through the edge gateway 31, and the fusion detection system 1000 (which is installed or disposed in the edge server 33) may obtain the sensing data-set SD from the edge database 32, or directly receive the sensing data-set SD from the edge gateway 31. The fused detection system 1000 performs model operations for anomaly detection and predictive maintenance based on the sensing data-set SD, so as to generate device information D_if and cost optimization decision CO_d. The device information D_if is sent to the head-mounted device 51. Then, the user 60 reads the device information D_if through the head-mounted device 51.

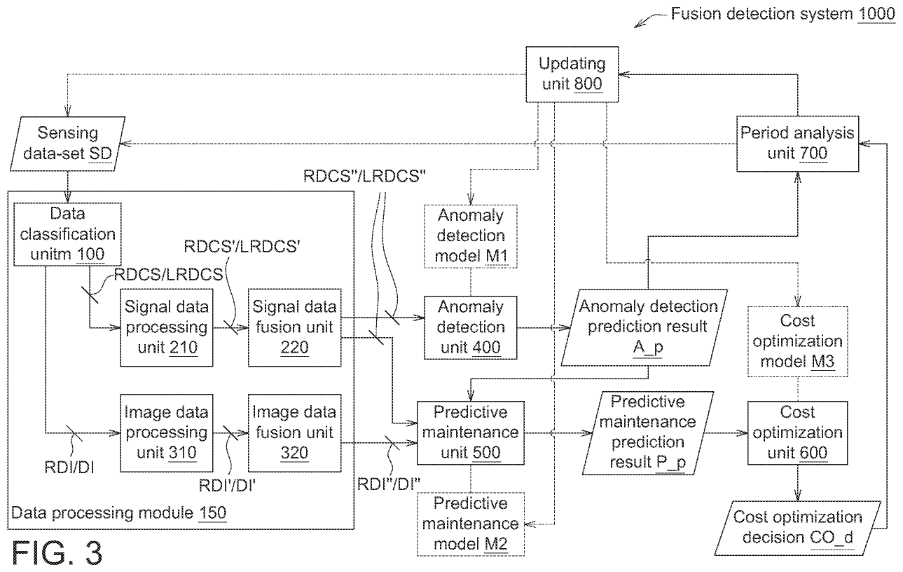

Please refer to FIG. 3, which illustrates a block diagram of a fusion detection system 1000 according to an embodiment of the present disclosure. The fusion detection system 1000 includes a data processing module 150, an anomaly detection unit 400, a predictive maintenance unit 500, a cost optimization unit 600, a period analysis unit 700 and an updating unit 800. Furthermore, the data processing module 150 includes a data classification unit 100, a signal data processing unit 210, a signal data fusion unit 220, an image data processing unit 310 and an image data fusion unit 320. In one example, the fusion detection system 1000 may be an application software installed in the edge server 33 of FIG. 2, and the above-mentioned several units may be subroutine modules of the fusion detection system 1000. In another example, the fusion detection system 1000 may be a hardware circuit in the edge server 33 of FIG. 2, such as a microprocessor, an application specific integrated circuit (ASIC), or a field programmable gate array (FPGA), and each of the above-mentioned several units may be a sub-circuit of the fusion detection system 1000.

The data classification unit 100 is communicatively coupled to the edge database 32 of FIG. 2, and the data classification unit 100 receives the sensing data-set SD from the edge database 32. As mentioned above, the sensing data-set SD is composed of the sensing data of each of the distributed devices 10 of the micro-grid. The data classification unit 100 classifies the sensing data included in the sensing data-set SD into a RDCS type, a LRDCS type, a RDI type and a DI type, as shown in Table 1.

TABLE 1

| Data | Types of | | | | |
|---|---|---|---|---|---|
| capturing | sensing | Distributed | Micro-grid | | |
| sources | data | devices | system | Environment | Fault type |
| Current | RDCS | ✓ | ✓ | — | Over-current, |
| sensor | | | | | Under-current |
| Voltage | RDCS | ✓ | ✓ | — | Over-voltage, |
| sensor | | | | | Under-voltage |
| Temperature | RDCS | ✓ | — | ✓ | Over-heating, |
| sensor | | | | | Thermal runaway |
| Smart meter | RDCS | ✓ | ✓ | — | Voltage sag, |
| | | | | | Over-voltage, |
| | | | | | Frequency deviation, |
| | | | | | Power quality |
| | | | | | monitoring |
| Weather | LRDCS | — | — | ✓ | Humidity, |
| sensor | | | | | Wind speed, |
| | | | | | Temperature |
| Camera | RDI | ✓ | ✓ | ✓ | Loose connections |
| (visible | | | | | and corroded wires, |
| image) | | | | | Environmental factors, |
| | | | | | Security breaches |
| Infrared | DI | ✓ | ✓ | ✓ | Hotspots |
| sensor | | | | | |
| (infrared | | | | | |
| image) | | | | | |

More specifically, the sensing data of the RDCS type are data of “real-time, dynamic, and continuous signal response”, which may be obtained by the current sensor 27, the voltage sensor 28, the temperature sensor 22 or the smart meter 21 in the data capturing devices 20. The fault type may be determined from the sensing data of the RDCS type as: over-current or under-current, over-voltage or under-voltage, over-heating or thermal runaway, or frequency deviation, etc.

The sensing data of the LRDCS type are data of “low frequency, real-time, dynamic, and continuous signal response”, which may be obtained by the weather sensors. The fault type may be determined from the sensing data of the LRDCS type as: humidity, wind speed or temperature, etc.

The sensing data of the RDI type are data of “real-time and dynamic image”, which may be captured by the camera 23 in the data capturing devices 20. The fault type may be determined from the sensing data of the RDI type as: loose connections, or corroded wires, etc.

The DI type sensing data are data of “dynamic image”, which may be captured by the infrared sensor 24 in the data capturing devices 20. The fault type may be determined from the DI type sensing data as: hotspots.

The sensing data of the RDCS and LRDCS types classified by the data classification unit 100 are sent to the signal data processing unit 210 for performing signal processing of Fast Fourier Transform (FFT), Wavelet Transform, (WT), Kalman filtering or Auto-Regressive Integrated Moving Average (ARIMA), etc. The signal processing performed by the signal data processing unit 210 may be referred to as “the first signal processing”. The sensing data of the RDCS and LRDCS types which are performed with signal processing (marked as RDCS′ and LRDCS′ in FIG. 3) are sent to the signal data fusion unit 220.

The signal data fusion unit 220 performs fusion processing of Intensity-Hue-Saturation (IHS), Principal Component Analysis (PCA) or pyramid algorithm, etc. The fusion processing performed by the signal data fusion unit 220 may be referred to as “the first fusion processing”. The sensing data of the RDCS and LRDCS types which are performed with fusion processing (marked as RDCS″ and LRDCS″ in FIG. 3) are sent to the anomaly detection unit 400 and the predictive maintenance unit 500.

On the other hand, the sensing data of the RDI and DI types which are classified by the data classification unit 100, are sent to the image data processing unit 310 for performing image processing of image filtering, noise reduction, image normalization, image separation, or feature extraction, etc. The image processing performed by the image data processing unit 310 may be referred to as “the first image processing”. The sensing data of the RDI and DI types which are performed with image processing (marked as RDI′ and DI′ in FIG. 3) are sent to the image data fusion unit 320.

The image data fusion unit 320 performs spatial-domain fusion processing and transformation-domain fusion processing, e.g., principal component analysis, weighted average method, Discrete Wavelet Transform DWT), Laplacian Pyramids (LP) or Gradient Pyramids (GP), etc. The fusion processing performed by the image data fusion unit 320 may be referred to as “the second fusion processing”. The sensing data of the RDI and DI types which are performed with fusion processing (marked as RDI″ and DI″ in FIG. 3) are sent to the predictive maintenance unit 500.

The anomaly detection unit 400 performs a model operation based on the anomaly detection model M1, such that the RDCS data and LRDCS data which are performed with fusion processing (marked as RDCS″ and LRDCS″ in FIG. 3) are performed with processing of Residual Network (ResNet), Visual Geometry Group Network (VGG_Net), K-Nearest Neighbors (KNN) or Support Vector Machines (SVM), etc. and generating an anomaly detection prediction result A_p. The anomaly detection prediction result A_p is transmitted to the prediction maintenance unit 500 based on a period T1 (e.g., 1 hour).

The predictive maintenance unit 500 performs a model operation based on the predictive maintenance model M2, such that the RDCS, LRDCS, RDI and DI data which are performed with fusion processing (marked as RDCS″, LRDCS″, RDI″ and DI″ in FIG. 3) are performed processing based on the anomaly detection prediction result A_p, e.g., residual network, K nearest neighbor, support vector machine, Long Short-Term Memory (LSTM), Q-Learning or Deep Deterministic Policy Gradient (DDPG), etc., and generating a predictive maintenance prediction result P_p. Then, the predictive maintenance prediction result P_p is sent to the cost optimization unit 600.

The cost optimization unit 600 performs a model operation based on the cost optimization model M3, so as to generate the cost optimization decision CO_d and the device information D_if. Then, the cost optimization decision CO_d and the anomaly detection prediction result A_p are sent to the period analysis unit 700.

The period analysis unit 700 is used to analyze period T1, period T2 and period T3 of timing sequence. The period T1 is, e.g., 1 hour. Furthermore, the period T2 is, e.g., 0.1 hour. Moreover, the period T3 is, e.g., 24 hours.

The period analysis unit 700 updates the sensing data-set SD based on the period T2 and in response to the anomaly detection prediction result A_p. For example, updated sensing data-set SD is obtained from the data capturing devices 20 in FIG. 1 for each period T2 (i.e., 0.1 hours). Furthermore, the period analysis unit 700 controls the updating unit 800 based on the period T3 and in response to the anomaly detection prediction result A_p, so as to update the sensing data-set SD and update the anomaly detection model M1 (i.e., updating the anomaly detection model M1 for each period T3).

On the other hand, the period analysis unit 700 updates the sensing data-set SD based on the period T1 and in response to the cost optimization decision CO_d. For example, updated sensing data-set SD is obtained from the data capturing devices 20 in FIG. 1 for each period T1 (i.e., 1 hour). Furthermore, the period analysis unit 700 controls the updating unit 800 based on the period T3 and in response to the cost optimization decision CO_d, thereby updating the sensing data-set SD, the predictive maintenance model M2 and the cost optimization model M3 (i.e., updating the predictive maintenance model M2 and the cost optimization model M3 once, for each period T3).

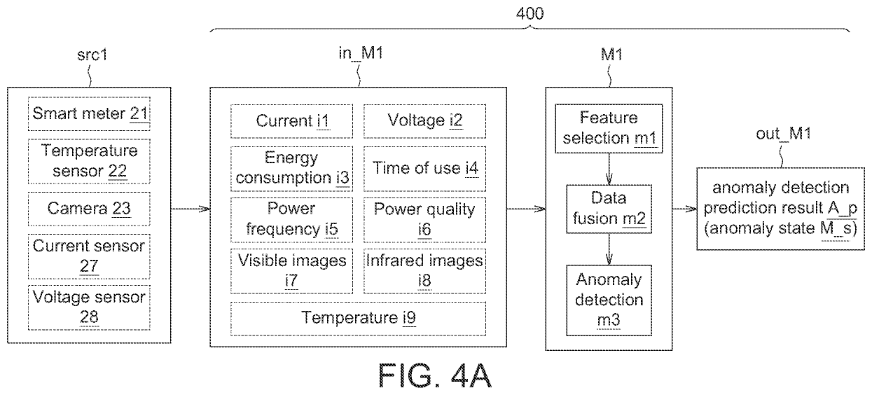

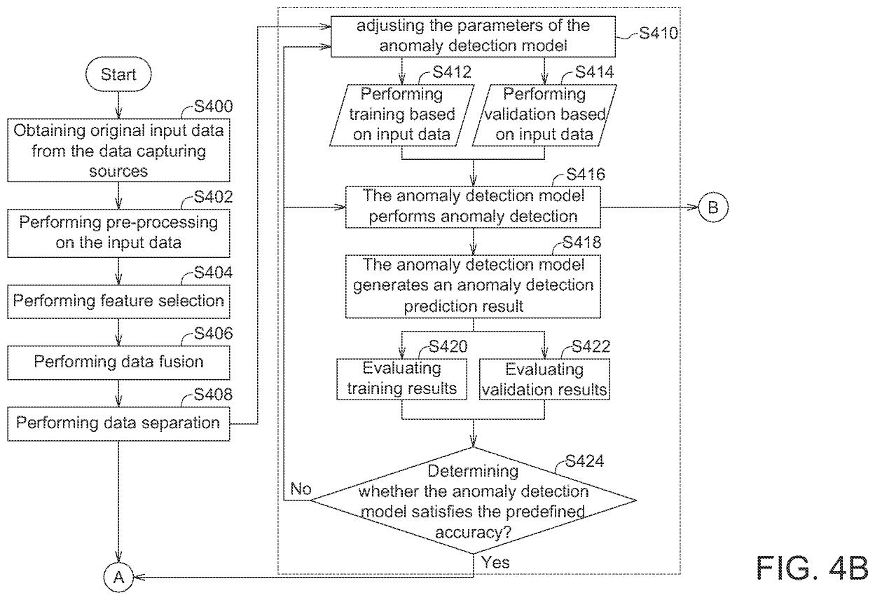

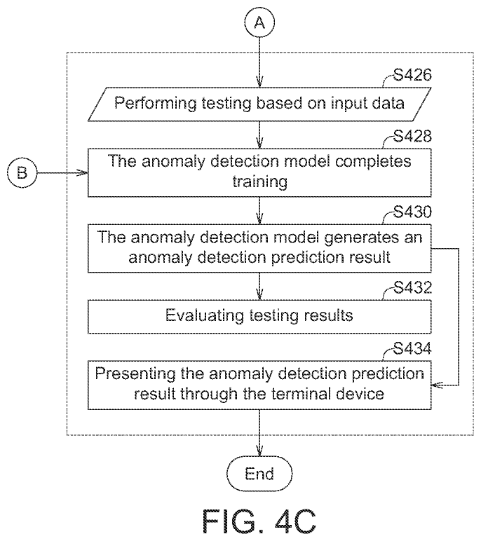

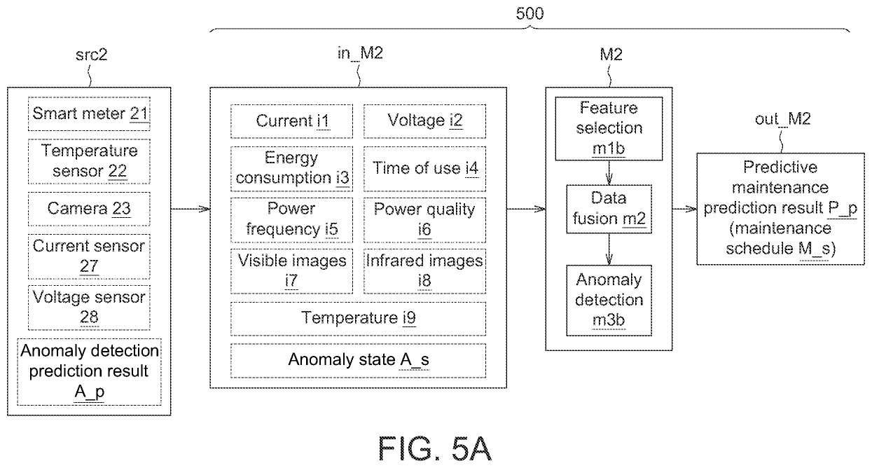

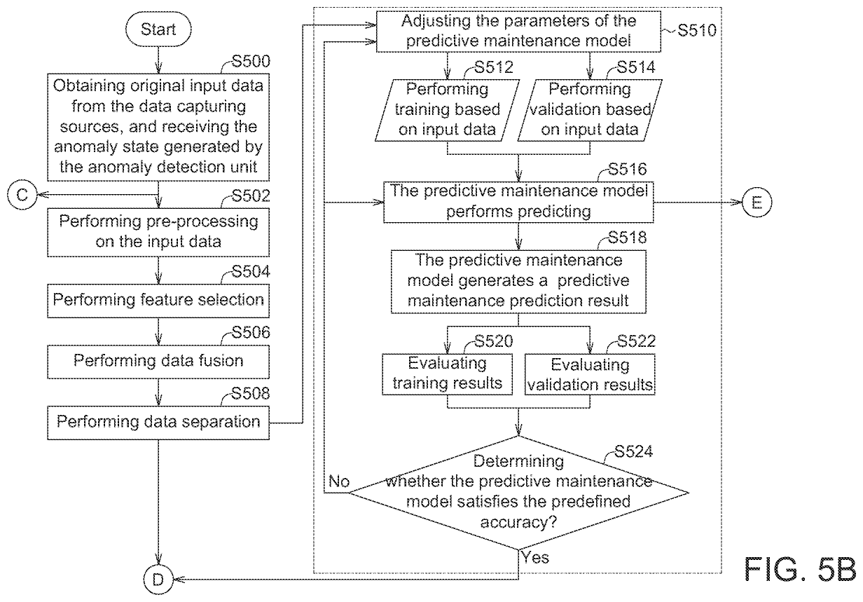

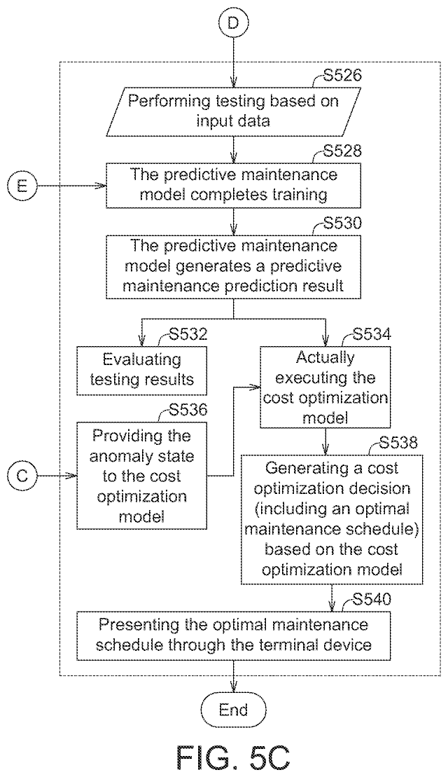

The details of model operations performed by the anomaly detection unit 400 and the predictive maintenance unit 500 are explained below in conjunction with FIGS. 4A to 4C and FIGS. 5A to 5C. Please refer to FIG. 4A, which illustrates a data structure used by the anomaly detection unit 400 when performing model operation. The data capturing sources src1 of the anomaly detection unit 400 may be the data capturing devices 20 in FIG. 1. The data capturing sources src1 include, e.g., a smart meter 21, a temperature sensor 22, a camera 23, a current sensor 27 and a voltage sensor 28, etc. (the data capturing sources src1 in FIG. 4A are also equivalent to the data capturing sources shown in Table 1). The data capturing sources src1 generate input data in_M1 which are provided to the anomaly detection model M1. The input data in_M1 includes, e.g., current i1, voltage i2, energy consumption i3, time of use i4, power frequency i5, power quality i6, visible images i7, infrared images 18 and temperature i9, etc.

The anomaly detection model M1 receives input data in_M1 to perform model operation. More specifically, based on machine learning, the anomaly detection model M1 performs the following operations: feature selection m1, data fusion m2 and anomaly detection m3. The operation of feature selection m1 is to establish and select useful features based on the input data in_M1. These useful features may be used as input variables of the anomaly detection model M1. For example, users with professional experience may assist to performing feature selection m1, so as to distinguish features in the input data in_M1 that will affect the output data out_M1 of the anomaly detection model M1 based on experience, and then select and extract these features. The operation of data fusion m2 may be executed by the signal data fusion unit 220 and the image data fusion unit 320 in FIG. 1. Furthermore, the operation of anomaly detection m3 includes model training and model prediction (i.e., operations of a training phase and a prediction phase of the anomaly detection model M1). After executing the feature selection m1, data fusion m2 and anomaly detection m3, the anomaly detection model M1 may generate output data out_M1. The output data out_M1 is the anomaly detection prediction result A_p in FIG. 3, which includes the anomaly state A_s of the distributed devices 10.

Next, please refer to FIGS. 4B and 4C, which illustrate an operating process of the anomaly detection unit 400. The operating process of the anomaly detection unit 400 refers to the following: continuously monitoring the sensing data of the distributed devices 10 of the micro-grid based on data-driven machine learning, and detecting the anomaly state of the distributed devices 10 in real-time. Steps S400 to S408 refer to pre-processing of the anomaly detection model M1. Firstly, in step S400, original input data in_M1 is obtained from the data capturing sources src1 (e.g., the camera 23 and the current sensor 27, etc.). Then, in step S402, pre-processing is performed on the original input data in_M1 which are obtained (the pre-processing may be executed by the data processing module 150 in FIGS. 1 and 3).

Then, in step S404, feature selection m1 in FIG. 4A is performed. Then, in step S406, data fusion m2 in FIG. 4A is performed (data fusion m2 may be performed by the signal data fusion unit 220 and the image data fusion unit 320 in FIG. 3). Then, in step S408, data separation is performed to facilitate subsequent training, validation and testing for the anomaly detection model M1.

After step S408, two branch-processes are then executed. The first branch-process refers to the training phase of the anomaly detection model M1, which includes steps S410 to S424. The second branch-process refers to the actual execution phase (i.e., the prediction phase) of the anomaly detection model M1, including steps S426 to S434.

When executing the first branch-process, firstly in step S410, the parameters (i.e., “hyper-parametric”) of the anomaly detection model M1 are adjusted (i.e., tuned). Then, in step S412, training is performed based on input data in_M1 which are performed with fusion processing. At the same time, in step S414, validation is performed based on input data in_M1 which are performed with fusion processing. Then, in step S416, the anomaly detection model M1 actually performs anomaly detection (i.e., the operation of anomaly detection m3 in FIG. 4A). Then, in step S418, the anomaly detection model M1 generates an anomaly detection prediction result A_p.

Then, in step S420, training results of the anomaly detection model M1 are evaluated. At the same time, in step S422, validation results of the anomaly detection model M1 are evaluated. Then, in step S424, it is determined whether the anomaly detection model M1 satisfies a predefined accuracy, based on the evaluations of the training results and the validation results. If the determination result in step S424 is “No”, then return to step S410 or step S416.

If the determination result of step S424 is “Yes” (indicating that the predefined accuracy is satisfied), then step S426 of the second branch-process is executed: testing is performed based on input data in_M1 which are performed with fusion processing. Then, in step S428, training of the anomaly detection model M1 is completed. Then, in step S430, anomaly detection is actually performed by the anomaly detection model M1, so as to generate the anomaly detection prediction result A_p (which includes the anomaly state A_s).

After step S430 is executed, steps S432 and S434 may be executed concurrently. In step S432, testing results of the anomaly detection model M1 are evaluated. The criteria for evaluation may include, e.g., Mean Absolute Error (MAE), Root Mean Square Error (RMSE) and Mean Absolute Percentage Error (MAPE), etc. On the other hand, in step S434, the anomaly detection prediction result A_p is presented to the user 60 through the terminal device 50 in FIG. 1.

Next, please refer to FIG. 5A, which illustrates a data structure used by the predictive maintenance unit 500 when performing model operations. The data structure shown in FIG. 5A is similar to the data structure in FIG. 4A, the difference is that: compared with the data capturing sources src1 in FIG. 4A, the data capturing sources src2 of the predictive maintenance unit 500 further include the anomaly detection prediction result A_p. Moreover, compared with the input data in_M1 in FIG. 4A, the input data in_M2 of the predictive maintenance model M2 further include the anomaly state A_s. That is, in addition to receiving sensing data generated by the data capturing sources src2, the predictive maintenance model M2 also receives the anomaly detection prediction result A_p (including the anomaly state A_s) generated by the anomaly detection model M1.

The predictive maintenance model M2 performs feature selection m1b, data fusion m2 and anomaly detection m3b based on the input data in_M2. The difference between the feature selection m1b performed by the predictive maintenance model M2 and the feature selection m1 performed by the anomaly detection model M1 is that: the feature selection m1b performed by the predictive maintenance model M2 converts the input data in_M2 into a new representing form, and then extracts basic attributes or features of the sensing data related to target tasks or target problems. The input data in_M2, which is converted, may be used as input variables for machine learning algorithms or statistical modeling. Furthermore, the anomaly detection m3b performed by the predictive maintenance model M2 is a simplified operation of the anomaly detection m3 in FIG. 4A. The predictive maintenance model M2 generates the output data out_M2, which is, the predictive maintenance prediction result P_p of FIG. 3, including a maintenance schedule M_s of each of the distributed devices 10. Based on the maintenance schedule M_s, the user may perform different types of maintenance on the distributed devices 10 of the micro-grid. For example, the maintenance schedule M_s includes the following types of maintenance: preventive maintenance (PM), corrective maintenance (CM), device replacement (R) and downtime (D). The “device replacement” type of maintenance is to replace an old and failed device with a new device. The “Downtime” type of maintenance is to shut-down the failed device compulsorily.

Next, please refer to FIGS. 5B and 5C, which illustrate an operating process of the predictive maintenance unit 500. The operating process of the predictive maintenance unit 500 refers to the follows: identifying risks and trends that the distributed devices 10 of the micro-grid may face failure or degradation based on data-driven machine learning, thereby predicting the maintenance needs of the distributed devices 10, and proactively providing maintenance strategy. The operating process of the predictive maintenance unit 500 is substantially similar to the operating process of the anomaly detection unit 400 shown in FIGS. 4B and 4C.

The pre-processing of the predictive maintenance model M2 includes steps S500 to S508. Step S500 is slightly different from step S400 in FIG. 4B, where step S500 further receives the anomaly state A_s generated by the anomaly detection unit 400.

Furthermore, the training phase of the predictive maintenance model M2 includes steps S510 to S524, which are substantially the same as the steps S410 to S424 of the training phase of the anomaly detection model M1 in FIG. 4B.

Moreover, the actual execution phase (i.e., the prediction phase) of the predictive maintenance model M2 includes steps S526 to step S540. The difference from the process of the prediction phase of the anomaly detection model M1 shown in FIG. 4C is that, in addition to performing step S532 to evaluate test results after step S530, it may concurrently execute step S534: cost optimization model M3 operates in the actual execution phase. Furthermore, in step S536, the anomaly state A_s is provided to the cost optimization model M3.

Subsequent to step S534, it may execute step S538: generating the cost optimization decision CO_d and the device information D_if based on the cost optimization model M3. The cost optimization decision CO_d includes the optimal maintenance schedule O_M_s. Then, in step S540, the device information D_if and the optimal maintenance schedule O_M_s are presented to the user 60 through the terminal device 50 in FIG. 1.

The cost optimization model M3 is used to perform model operations for cost optimization, so as to minimize maintenance cost of the micro-grid and allow the operator of the micro-grid to make the most cost-effective maintenance decision. An objective function of the model operation of the cost optimization model M3 is shown in equation (1). When the objective function reaches a minimum value, the minimum maintenance cost may be obtained.

$${\sum }_{i = 1}^{I} {\sum }_{j = 1}^{J} {\sum }_{k = 1}^{K} {\sum }_{t = 1}^{T} \{ {C}_{i t}^{( k )} {x}_{i j t}^{( k )} \} \qquad ( 1 )$$

Indexes and parameters of equation (1) are described as follows. “i” represents the type of distributed devices 10 of the micro-grid. The distributed devices 10 of the micro-grid may be referred to as “distributed energy resources (DER)”, hence “i” also represents the type of distributed energy source, where, i∈I, and the set “I” includes: solar photovoltaic (PV), battery energy storage system (BESS) and wind turbine (WT), etc. Furthermore, “j” represents the number of specific types of distributed devices 10, where j∈J. Moreover, “k” represents the type of maintenance, where k∈K, and the set “K” includes: preventive maintenance, corrective maintenance, device replacement and downtime. In addition, “t” represents the time interval, where t∈T.

Still, “xᵢⱼₜ^{(k)}” is a decision variable, and “Cᵢₜ^{(k)}” represents a dynamic it maintenance cost associated with time t, distributed devices 10 of type i, and selected maintenance type k. Furthermore, “Cᵢₜ^{(k)}” is represented by equation (2).

$${C}_{ijt}^{( k )} = \{ {L}^{M} , {ME}_{i t}^{p m} , {ME}_{i t}^{c m , i} , {P}_{i t}^{d , loss} , {P}_{i t}^{d , penalty} , {CP}_{i t}^{r} \} \qquad ( 2 )$$

In equation (2), “L^{M}” is labor cost. “MEᵢₜ^{pm}” and “MEᵢₜ^{cm,i}” are material costs and equipment costs. “Pᵢₜ^{d,loss}” is the production loss during downtime. “Pᵢₜ^{d,penalty}” is the contract penalty fee for failing of contractual obligations due to downtime. “CPᵢₜ^{r}” is the device replacement cost in the “device replacement” type of maintenance.

On the other hand, constraints of the cost optimization model M3 refer to equations (3-1)-(3-9). More specifically, equation (3-1) represents a “budget constraint” that is used to limit the total maintenance cost, which considers different maintenance types k for each group j of distributed devices 10 of type i, at each time t. In which, “B” represents the maximum maintenance budget in the micro-grid. “xᵢⱼₜ^{(k)}” represents a maintenance decision variable associated with time t, the j-th group of distributed devices 10 of type i and the selected maintenance type k.

$${\sum }_{i = 1}^{I} {\sum }_{j = 1}^{J} {\sum }_{k = 1}^{K} \{ {C}_{i t}^{( k )} \cdot {x}_{i j t}^{( k )} \} \leq B , ∀ t ∈ T \qquad ( 3 - 1 )$$

Equation (3-2) represents a “single maintenance type constraint”, which is used to restrict each group j of distributed devices 10 of type i to select only one maintenance type, at each time t.

$${\sum }_{k = 1}^{K} {x}_{i j t}^{( k )} \leq 1 , ∀ i ∈ I , ∀ j ∈ J , ∀ t ∈ T \qquad ( 3 - 2 )$$

Equation (3-3) represents a “predictive maintenance constraint”, used to restrict to execute preventive maintenance to only the distributed devices 10 needed to be maintained for the maintenance schedule. “Fᵢₜ^{(k)}” represents a predictive maintenance plan associated with time t, the j-th group of distributed devices 10 of type i, and the selected maintenance type k. Furthermore, Fᵢⱼₜ^{(k)}∈{0,1}. When Fᵢⱼₜ^{(k)}=1, it means that the equipment or device needs maintenance. On the contrary, when Fᵢⱼₜ^{(k)}=0, it means no maintenance is required.

$${\sum }_{j = 1}^{J} \{ {F}_{i j t}^{( k )} \cdot {x}_{i j t}^{( k )} \} \leq 1 , ∀ i ∈ I , ∀ t ∈ T \qquad ( 3 - 3 )$$

Equation (3-4) represents a “working asset constraint”, used to restrict maintenance from being performed on assets already running. “Dᵢⱼₜ” represents the state detected for the j-th group of distributed devices 10 of type i, at time t. When Dᵢⱼₜ=1, it means that the distributed devices 10 of this group are operating. On the contrary, when Dᵢⱼₜ=0, it means that the distributed devices 10 of this group are not operating.

$${D}_{i j t} \leq {\sum }_{j = 1}^{J} {\sum }_{k = 1}^{K} {x}_{ijk}^{( k )} , ∀ i ∈ I , ∀ t ∈ T \qquad ( 3 - 4 )$$

Equation (3-5) represents a “decision variable constraint”, which is used to restrict the decision variables as binary variables.

$${x}_{i j t}^{( k )} ∈ \{ 0 , 1 \} \qquad ( 3 - 5 )$$

Equations (3-6) to (3-9) represent “dynamic maintenance cost equations”, which are dynamic maintenance cost associated with the distributed devices 10 of type i and the selected maintenance type k.

$${C}_{i t}^{p m} = {L}_{i t}^{p m} + M {E}_{i t}^{p m} \qquad ( 3 - 6 )$$

$${C}_{i t}^{c m} = {L}_{i t}^{c m} + M {E}_{i t}^{c m} \qquad ( 3 - 7 )$$

$${C}_{i t}^{r} = {L}_{i t}^{r} + C {P}_{i t}^{r} \qquad ( 3 - 8 )$$

$${C}_{i t}^{d , loss} = {P}_{i t}^{d , loss} + {P}_{i t}^{d , penalty} \qquad ( 3 - 9 )$$

In the operation of the cost optimization model M3, the objective function of equation (1) must comply with the constraints of equations (3-1)-(3-9). When the constraints of equations (3-1)-(3-9) are satisfied, the minimum maintenance cost is calculated based on the objective function with the minimum value. When the minimum maintenance cost is reached, the cost optimization decision CO_d (including the optimal maintenance schedule O_M_s) may be obtained.

In summary, the fusion detection system 1000 of the present disclosure provides real-time anomaly detection and optimal predictive maintenance for micro-grids. The fusion detection system 1000 has the following solutions and technical effects:
(1) The fusion detection system 1000 performs fusion operations on different types of sensing data (including real-time or low-frequency signals and images, etc.) of the distributed devices 10 of the micro-grid. The fusion detection system 1000 has data fusion technology for processing different types of sensing data.
(2) When the fusion detection system 1000 immediately detects the anomaly state A_s of the distributed devices 10 of the micro-grid, it issues an alert or a device health indicator to inform the micro-grid operator to take immediate action. Moreover, the predictive maintenance model M2 of the fusion detection system 1000 is closely related to the anomaly detection model M1, thereby providing predictive maintenance services for the immediate maintenance needs of the micro-grid.
(3) The cost optimization model M3 of the fusion detection system 1000 considers the dynamic maintenance cost, labor cost, material and equipment cost, production losses, and penalty costs for delayed or failed maintenance, based on the current market price, so as to plan the most effective optimized cost. Moreover, the optimized cost in conjunction with the predictive maintenance prediction result P_p of the fusion detection system 1000, may obtain the optimal maintenance schedule O_M_s with the minimum cost to provide the most cost-effective maintenance schedule for the micro-grid.
(4) The fusion detection system 1000 may also cooperate with the cloud computing platform and an edge computing platform (including the edge database 32 and the edge server 33), so as to combine cloud computing and edge computing based on IoT. Hence, it may be applied to micro-grids with different scales.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A fusion detection system, comprising:
data processing module, for performing a pre-processing on a sensing data-set, the sensing data-set comprises a plurality of sensing data of a plurality of distributed devices, and the data processing module comprising:
a data classification unit, for receiving the sensing data, and classifying the sensing data into a first type, a second type, a third type and a fourth type, wherein the sensing data are captured by a data capturing device;
an anomaly detection unit, for performing an operation of an anomaly detection model based on the sensing data of the first type and the second type which are performed with a first fusion processing, so as to generate an anomaly detection prediction result;
a predictive maintenance unit, for performing an operation of a predictive maintenance model based on the sensing data of the first type and the second type which are performed with a first fusion processing, the sensing data of the third type and the fourth type which are performed with a second fusion processing and the anomaly detection prediction result, so as to generate a predictive maintenance prediction result, the predictive maintenance prediction result is used to plan a predictive maintenance policy; and
a cost optimization unit, for performing an operation of a cost optimization model based on the predictive maintenance prediction result to generate a cost optimization decision.

2. The fusion detection system according to claim 1, which is integrated into an Internet of Things (IoT) architecture, and the IoT architecture comprises the distributed devices, the data capturing device, an edge gateway, an edge server and a cloud computing platform.

3. The fusion detection system according to claim 2, which is installed or disposed in the edge server, and the edge server comprises an edge database.

4. The fusion detection system according to claim 3, wherein the data capturing device transmits the sensing data-set to the edge server through the edge gateway, and the sensing data-set is stored in the edge database.

5. The fusion detection system according to claim 3, wherein the data processing module receives the sensing data-set through the edge gateway to perform the pre-processing, and the pre-processing comprises data processing and transformation and data mining.

6. The fusion detection system according to claim 5, wherein the anomaly detection unit and the predictive maintenance unit respectively perform an anomaly detection and a predictive maintenance based on sensing data-set which is performed with the pre-processing, so as to generate a device information.

7. The fusion detection system according to claim 6, wherein the cost optimization decision comprises a decision of the anomaly detection and a decision of the predictive maintenance, and the decision of the predictive maintenance comprises an optimal maintenance schedule of each of the distributed devices, and the decision of the anomaly detection comprises an alert and a device health indicator.

8. The fusion detection system according to claim 7, wherein the optimal maintenance schedule comprises preventive maintenance, corrective maintenance or device replacement.

9. The fusion detection system according to claim 7, wherein the device health indicator comprises probabilistic anomaly score, mean time between failures, failure rate and remaining useful life of each of the distributed devices.

10. The fusion detection system according to claim 6, wherein the cloud computing platform comprises a message broker unit, a data streaming unit and a cloud database, and the cloud computing platform receives the device information and this cost optimization decision from the edge server.

11. The fusion detection system according to claim 10, wherein after the message broker unit and the data streaming unit process the device information and the cost optimization decision, the cost optimization decision is stored in the In a cloud database, and the device information is displayed on a terminal device and presented to a user, wherein the device information comprises an anomaly state of each of the distributed devices.

12. The fusion detection system according to claim 11, wherein the anomaly detection prediction result comprises the anomaly state.

13. The fusion detection system according to claim 1, wherein the first type is a type of real-time dynamic and continuous signal response (RDCS), and the second type is a type of low-frequency real-time dynamic and continuous signal response (LRDCS), the third type is a type of real-time dynamic image (RDI), and the fourth type is a type of dynamic image (DI).

14. The fusion detection system according to claim 1, wherein the data processing module further comprising:
a signal data fusion unit, for performing the first fusion processing on the sensing data of the first type and the second type, the first fusion processing comprises intensity-hue-saturation processing, principal component analysis or pyramid algorithm processing; and
an image data fusion unit, for performing the second fusion processing on the sensing data of the third type and the fourth type, the second fusion processing comprises principal component analysis, weighted average method, discrete wavelet transform, Laplacian pyramids or gradient pyramids processing.

15. The fusion detection system according to claim 14, wherein the data processing module further comprising:
a signal data processing unit, for performing a first signal processing on the sensing data of the first type and the second type before the first fusion processing, the first signal processing comprises fast fourier-transform, wavelet transform, Kalman filtering, or auto-regressive integrated moving average; and
an image data processing unit, for performing a first image processing on the sensing data of the third type and the fourth type before the second fusion processing, the first image processing comprises image filtering, noise reduction, image normalization, image separation, or feature extraction.

16. The fusion detection system according to claim 1, wherein the data capturing device is disposed on the distributed devices or a terminal device, and the data capturing device comprises a current sensor, a voltage sensor, a temperature sensor, a smart meter, a weather sensor, a camera or an infrared sensor.

17. The fusion detection system according to claim 16, wherein the sensing data of the first type are signal data obtained by the current sensor, the voltage sensor, the temperature sensor or the smart meter, and the sensing data of the second type are signal data captured by the weather sensor.

18. The fusion detection system according to claim 16, wherein the sensing data of the third type are visible image data captured by the camera, and the sensing data of the fourth type are infrared image data captured by the infrared sensor.

19. The fusion detection system according to claim 1, further comprising:
an updating unit; and
a period analysis unit, for performing the following operations:
updating the sensing data in response to the cost optimization decision and based on a first period, and controlling the updating unit to update the predictive maintenance model and the cost optimization model based on a third period; and
updating the sensing data in response to the anomaly detection prediction result and based on a second period, and controlling the updating unit to update the anomaly detection model based on the third period.

20. The fusion detection system according to claim 1, wherein the cost optimization model is operated based on an objective function, and a dynamic maintenance cost of the objective function comprises a labor cost, a material cost, an equipment cost and a device replacement cost.

21. A fusion detection method, comprising:
capturing a plurality of sensing data from a plurality of distributed devices by a data capturing device, and the sensing data form a sensing data-set;
performing a pre-processing on the sensing data-set by a data processing module;
receiving the sensing data of a plurality of distributed devices and classifying the sensing data into a first type, a second type, a third type and a fourth type, by a data classification unit of the data processing module;
performing an operation of an anomaly detection model based on the sensing data of the first type and the second type which are performed with a first fusion processing, so as to generate an anomaly detection prediction result, by an anomaly detection unit;
performing an operation of a predictive maintenance model based on the sensing data of the first type and the second type which are performed with a first fusion processing, the sensing data of the third type and the fourth type which are performed with a second fusion processing and the anomaly detection prediction result, so as to generate a predictive maintenance prediction result, by a predictive maintenance unit, the predictive maintenance prediction result is used to plan a predictive maintenance policy; and
performing an operation of a cost optimization model based on the predictive maintenance prediction result to generate a cost optimization decision, by a cost optimization unit.

22. The fusion detection method according to claim 21, wherein the fusion detection method is operated in an Internet of Things (IoT) architecture, and the IoT architecture comprises the distributed devices, the data capturing device, an edge gateway, an edge server and a cloud computing platform.

23. The fusion detection method according to claim 22, wherein the fusion detection method is executed by a hardware element or a software program disposed in the edge server, and the edge server comprises an edge database.

24. The fusion detection method according to claim 23, wherein after the step of capturing the sensing data by the data capturing device, further comprising:
transmitting the sensing data-set to the edge server through the edge gateway by the data capturing device; and
storing the sensing data-set in the edge database.

25. The fusion detection method according to claim 23, wherein the step of performing the pre-processing by the data processing module comprising:
receiving the sensing data-set through the edge gateway to perform the pre-processing by the data processing module, and the pre-processing comprises data processing and transformation and data mining.

26. The fusion detection method according to claim 25, wherein the step of performing the operation of the anomaly detection model by the anomaly detection unit and performing the operation of the predictive maintenance model by the predictive maintenance unit comprising:
respectively performing an anomaly detection and a predictive maintenance based on sensing data-set which is performed with the pre-processing by the anomaly detection unit and the predictive maintenance unit, so as to generate a device information.

27. The fusion detection method according to claim 26, wherein the cost optimization decision comprises a decision of the anomaly detection and a decision of the predictive maintenance, and the decision of the predictive maintenance comprises an optimal maintenance schedule of each of the distributed devices, and the decision of the anomaly detection comprises an alert and a device health indicator.

28. The fusion detection method according to claim 27, wherein the optimal maintenance schedule comprises preventive maintenance, corrective maintenance or device replacement.

29. The fusion detection method according to claim 27, wherein the device health indicator comprises probabilistic anomaly score, mean time between failures, failure rate and remaining useful life of each of the distributed devices.

30. The fusion detection method according to claim 26, wherein the cloud computing platform comprises a message broker unit, a data streaming unit and a cloud database, and the fusion detection method further comprising:
receiving the device information and this cost optimization decision from the edge server by the cloud computing platform.

31. The fusion detection method according to claim 30, further comprising:
processing the device information and the cost optimization decision by the message broker unit and the data streaming unit;
storing the cost optimization decision in the cloud database; and
displaying the device information on a terminal device and presenting the device information to a user;
wherein, the device information comprises an anomaly state of each of the distributed devices.

32. The fusion detection method according to claim 31, wherein the anomaly detection prediction result comprises the anomaly state.

33. The fusion detection method according to claim 21, wherein the first type is a type of real-time dynamic and continuous signal response (RDCS), and the second type is a type of low-frequency real-time dynamic and continuous signal response (LRDCS), the third type is a type of real-time dynamic image (RDI), and the fourth type is a type of dynamic image (DI).

34. The fusion detection method according to claim 21, further comprising:
performing the first fusion processing on the sensing data of the first type and the second type, by a signal data fusion unit of the data processing module, the first fusion processing comprises intensity-hue-saturation processing, principal component analysis or pyramid algorithm processing; and
performing the second fusion processing on the sensing data of the third type and the fourth type, by an image data fusion unit of the data processing module, the second fusion processing comprises principal component analysis, weighted average method, discrete wavelet transform, Laplacian pyramids or gradient pyramids processing.

35. The fusion detection method according to claim 34, further comprising:
before the first fusion processing, performing a first signal processing on the sensing data of the first type and the second type by a signal data processing unit of the data processing module, and the first signal processing comprises fast fourier-transform, wavelet transform, Kalman filtering, or auto-regressive integrated moving average; and
before the second fusion processing, performing a first image processing on the sensing data of the third type and the fourth type by an image data processing unit of the data processing module, and the first image processing comprises image filtering, noise reduction, image normalization, image separation, or feature extraction.

36. The fusion detection method according to claim 21, wherein the data capturing device is disposed on the distributed devices or a terminal device, and the data capturing device comprises a current sensor, a voltage sensor, a temperature sensor, a smart meter, a weather sensor, a camera or an infrared sensor.

37. The fusion detection method according to claim 36, wherein before the step of receiving the sensing data of the distributed devices, further comprising:
capturing the sensing data of the first type by the current sensor, the voltage sensor, the temperature sensor or the smart meter; and
capturing the sensing data of the second type by the weather sensor.

38. The fusion detection method according to claim 36, wherein before the step of receiving the sensing data of the distributed devices, further comprising:
capturing the sensing data of the third type are by the camera; and
capturing the sensing data of the fourth type by the infrared sensor.

39. The fusion detection method according to claim 21, further comprises performing the following operations by a period analysis unit:
updating the sensing data in response to the cost optimization decision and based on a first period, and controlling an updating unit to update the predictive maintenance model and the cost optimization model based on a third period; and
updating the sensing data in response to the anomaly detection prediction result and based on a second period, and controlling the updating unit to update the anomaly detection model based on the third period.

40. The fusion detection method according to claim 21, wherein the cost optimization model is operated based on an objective function, and a dynamic maintenance cost of the objective function comprises a labor cost, a material cost, an equipment cost and a device replacement cost.
